(19) United States
(12) Patent Application Publication
(10) Pub. No.: US 2015/0296553 A1
(43) Pub. Date: Oct. 15, 2015

(54) SYSTEMS, DEVICES, AND METHODS THAT ESTABLISH PROXIMITY-BASED WIRELESS CONNECTIONS

(71) Applicant: Thalmic Labs Inc., Kitchener (CA)

(72) Inventors: Mark P. DiFranco, Kitchener (CA); Daniel Chung, Kitchener (CA)

(21) Appl. No.: 14/679,850

(22) Filed: Apr. 6, 2015

Related U.S. Application Data
(60) Provisional application No. 61/978,608, filed on Apr. 11, 2014.

(51) Int. Cl. H04W 76/02; H04W 8/00; H04W 4/00

(52) U.S. Cl. CPC H04W 76/023; H04W 4/008; H04W 8/005

(57) ABSTRACT

Systems, devices, and methods establish proximity-based wireless connections. A first electronic device and a second electronic device are each operated in respective “connection establishment modes” in which the first electronic device wirelessly transmits wireless signals and the second electronic device wirelessly receives at least one of the signals and determines an indication of a distance between the two devices based on a property of the received signal(s). If the distance is found to be below a threshold, a wireless connection is established between the two devices. In this way, a user may selectively pair a portable electronic device with a particular one of any number of available electronic devices by momentarily placing the portable electronic device in close proximity to the particular electronic device with which a wireless connection is desired.

### BACKGROUND

### Technical Field

The present systems, devices, and methods generally relate to wireless communications and particularly relate to establishing a specific wireless connection based on proximity when multiple wireless connections may be available.

### DESCRIPTION OF THE RELATED ART

### Portable and Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be designed to operate without any wire-connections to other electronic systems; however, a small and lightweight electronic device may still be considered portable even if it includes a wire-connection to another electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on.

### Wireless Communications

As described above, a portable electronic device may be designed to operate, at least in some modes, without any wire-connections to other electronic devices. The exclusion of external wire-connections enhances the portability of a portable electronic device. In order to interact with other electronic devices in the absence of external wire-connections, portable electronic devices (i.e., wearable or otherwise) commonly employ wireless communication techniques. A person of skill in the art will be familiar with common wireless communication protocols, such as Bluetooth®, ZigBee®, WiFi®, Near Field Communication (NFC), and the like.

There are specific challenges that arise in wireless communications that are not encountered in wire-based communications. For example, establishing a direct and isolated communicative link (i.e., a “connection”) between two electronic devices is quite straightforward in wire-based communications: connect a first end of a wire to a first device and a second end of the wire to a second device. Conversely, the same thing is much less straightforward in wireless communications. Wireless signals are typically broadcast out in the open and may impinge upon any and all electronic devices within range. In order to limit a wireless interaction to be between specific electronic devices (e.g., between a specific pair of electronic devices), the wireless signals themselves are typically configured to be receivable or usable by only the specific device(s) to which the signals are intended to be transmitted (i.e., by which the signals are intended to be received). For example, wireless signals may be encrypted and an intended receiving device may be configured to decrypt the signals, and/or wireless signals may be appended with “device ID” information that causes only the device bearing the matching “device ID” to respond to the wireless signal.

Wireless connections are advantageous in portable electronic devices because wireless connections enable a portable electronic device to interact with a wide variety of other devices without being encumbered by wire connections and without having to physically connect/disconnect to/from any of the other devices. However, the complicated signal configurations that are necessary to effect one-to-one (one:one) wireless communication between specific devices can make it difficult to establish and swap wireless connections. Significant signal restructuring is usually necessary in order to break a first wireless connection between a first device and a second device and to establish a second wireless connection between the first device and a third device. Typically, the process of disconnecting from a first device and establishing a new connection with a second device is initiated manually by the user (by, for example, pushing and often holding down a button) and is unduly extensive. Usually, after the first connection is broken, either the transmitting (e.g., peripheral) or the receiving (e.g., central) device (or both) enters into a “connection establishment mode” in which it scans for available wireless connections and the user must manually select which available wireless connection is desired. Some portable electronic devices do not include a display or other means to readily convey a list of available wireless connections to the user. The advantages of device portability and communicative versatility afforded by wireless connections are diminished by the extended processing effort that is often required to establish and swap between connections. There remains a need in the art for systems, devices, and methods that rapidly and reliably establish and select between multiple wireless connections.

### Received Signal Strength Indication

In telecommunications, a received signal strength indication (“RSSI”) is an indication of the power present in a radio signal at the point/location where the signal is received, as opposed to at the point/location where the signal is transmitted. There is no standard relationship between RSSI values and radio signal power levels, and there is no standard unit or scale for RSSI. For example, RSSI values may be represented as decibels (dB) or with arbitrary units, e.g., from 0 to RSSI_Max. Any given supplier or user of telecommunications devices may define and implement their own form of RSSI; however, as a measure of signal strength RSSI is generally inversely proportional to the distance between the point/location where a radio signal is received and the point/location where the radio signal is transmitted.

### BRIEF SUMMARY

A method of establishing a wireless connection between a first electronic device and a second electronic device, may be summarized as including: wirelessly transmitting signals by the first electronic device, wherein the signals wirelessly transmitted by the first electronic device include device identity information that at least partially identifies the first electronic device; wirelessly receiving, by the second electronic device, at least one of the signals wirelessly transmitted by the first electronic device; determining, by the second electronic device, an indication of a distance between the first electronic device and the second electronic device based on a property of the at least one signal wirelessly received by the second electronic device; and in response to the second electronic device determining that the distance between the first electronic device and the second electronic device is below a threshold: establishing a wireless connection between the first electronic device and the second electronic device. The method may further include, in response to the second electronic device determining that the distance between the first electronic device and the second electronic device is above the threshold and/or until the second electronic device determines that the distance between the first electronic device and the second electronic device is below the threshold: wirelessly receiving, by the second electronic device, at least one additional one of the signals wirelessly transmitted by the first electronic device; and determining, by the second electronic device, an indication of a distance between the first electronic device and the second electronic device based on a property of the at least one additional signal wirelessly received by the second electronic device. The first electronic device may include at least a wireless transmitter and the second electronic device may include at least a wireless receiver, and: wirelessly transmitting signals by the first electronic device may include wirelessly transmitting signals by the wireless transmitter of the first electronic device; and wirelessly receiving, by the second electronic device, at least one of the signals wirelessly transmitted by the first electronic device may include wirelessly receiving, by the wireless receiver of the second electronic device, at least one of the signals wirelessly transmitted by the wireless transmitter of the first electronic device. Wirelessly transmitting signals by the first electronic device may include wirelessly transmitting advertising data by the first electronic device.

The second electronic device may determine that the distance between the first electronic device and the second electronic device is below the threshold when the property of the at least one signal wirelessly received by the second electronic device is above a defined percentage (e.g., about 10%, 50%, 70%, 90%, or 99%) of a maximum value of the property for the at least one signal wirelessly received by the second electronic device, where the maximum value of the property corresponds to an at least approximately zero distance between the first electronic device and the second electronic device.

The property of the at least one signal wirelessly received by the second electronic device and based upon which the second electronic device determines an indication of a distance between the first electronic device and the second electronic device may be selected from the group consisting of: a power of the at least one signal, a strength of the at least one signal, and a received signal strength indication (“RSSI”) of the at least one signal. Establishing a wireless connection between the first electronic device and the second electronic device may include pairing the first electronic device and the second electronic device. Establishing a wireless connection between the first electronic device and the second electronic device may include wirelessly connecting with the first electronic device by the second electronic device.

The second electronic device may determine that the distance between the first electronic device and the second electronic device is below the threshold when the property of the at least one signal wirelessly received by the second electronic device indicates that the first electronic device is positioned within a defined radius (e.g., about 1 meter, 30 centimeters, 10 centimeters, 1 centimeter, or 1 millimeter) of the second electronic device.

The second electronic device may include a processor and a non-transitory processor-readable storage medium communicatively coupled to the processor, where the non-transitory processor-readable storage medium stores processor-executable proximity-based wireless connection instructions that, when executed by the processor of the second electronic device, cause the second wearable electronic device to: wirelessly receive the at least one of the signals wirelessly transmitted by the first electronic device; determine the indication of the distance between the first electronic device and the second electronic device based on the property of the at least one signal wirelessly received; and in response to the second electronic device determining that the distance between the first electronic device and the second electronic device is below the threshold: establish the wireless connection between the first electronic device and the second electronic device.

Wirelessly transmitting signals by the first electronic device may include wirelessly transmitting signals that include both device identity information that at least partially identifies the first electronic device and device functionality information that at least partially describes a functionality of the first electronic device.

The method may further include scanning for wireless signals that include device identity information by the second electronic device.

An electronic system may be summarized as including: a first electronic device that includes a wireless transmitter, wherein in use the wireless transmitter wirelessly transmits signals with device identity information that at least partially identifies the first electronic device, and wherein the first electronic device is a portable electronic device; a second electronic device that includes a processor, a wireless receiver communicatively coupled to the processor, and a non-transitory processor-readable storage medium communicatively coupled to the processor, wherein the non-transitory processor-readable storage medium stores processor-executable proximity-based wireless connection instructions that, when executed by the processor, cause the second electronic device to: wirelessly receive at least one signal wirelessly transmitted by the first electronic device; determine an indication of a distance between the first electronic device and the second electronic device based on a property of the at least one signal wirelessly received; and in response to the second electronic device determining that the distance between the first electronic device and the second electronic device is below a threshold: establish a wireless connection between the first electronic device and the second electronic device. The processor-executable proximity-based wireless connection instructions, when executed by the processor of the second electronic device, may further cause the second electronic device to, in response to the second electronic device determining that the distance between the first electronic device and the second electronic device is above the threshold and/or until the second electronic device determines that the distance between the first electronic device and the second electronic device is below the threshold: wirelessly receive at least one additional signal wirelessly transmitted by the first electronic device; and determine an indication of a distance between the first electronic device and the second electronic device based on a property of the at least one additional signal wirelessly received.

The first electronic device may be a wearable electronic device, such as a gesture-based control device.

In use, the wireless transmitter of the first electronic device wirelessly transmits signals with device functionality information that at least partially describes a functionality of the first electronic device and/or the wireless transmitter of the first electronic device wirelessly transmits signals with advertising data, wherein the advertising data includes device identity information that at least partially identifies the first electronic device.

When executed by the processor of the second electronic device, the processor-executable proximity-based wireless connection instructions may cause the second electronic device to determine that the distance between the first electronic device and the second electronic device is below the threshold when the property of the at least one signal wirelessly received by the second electronic device is above a defined percentage (e.g., at least about 10%, 50%, 70%, 90%, or 99%) of a maximum value of the property for the at least one signal wirelessly received by the second electronic device, wherein the maximum value of the property corresponds to an at least approximately zero distance between the first electronic device and the second electronic device.

The property of the at least one signal wirelessly received by the second electronic device and based upon which the processor-executable proximity-based wireless connection instructions, when executed by the processor of the second electronic device, cause the second electronic device to determine an indication of a distance between the first electronic device and the second electronic device may be selected from the group consisting of: a power of the at least one signal, a strength of the at least one signal, and a received signal strength indication (“RSSI”) of the at least one signal.

The first electronic device may be positioned within about 1 meter, 30 centimeters, 10 centimeters, 1 centimeter, of 1 millimeter of the second electronic device. When executed by the processor of the second electronic device, the processor-executable proximity-based wireless connection instructions may cause the second electronic device to determine that the distance between the first electronic device and the second electronic device is below the threshold when the property of the signal wirelessly received by the second electronic device indicates that the first electronic device is positioned within a defined radius (e.g., about 1 meter, 30 centimeters, 10 centimeters, 1 centimeter, of 1 millimeter) of the second electronic device

A method of operating an electronic device to establish a wireless connection may be summarized as including: wirelessly receiving a wireless signal by the electronic device; determining, by the electronic device, an indication of a distance between the electronic device and a source of the wireless signal based on a property of the wireless signal; and in response to the electronic device determining that the distance between the electronic device and the source of the wireless signal is below a threshold: establishing a wireless connection with the source of the wireless signal by the electronic device. The method may further include, in response to the electronic device determining that the distance between the electronic device and the source of the wireless signal is above the threshold and/or until the electronic device determines that the distance between the electronic device and the source of the wireless signal is below the threshold: wirelessly receiving, by the electronic device, at least one additional wireless signal; and determining, by the electronic device, an indication of a distance between the electronic device and the source of the at least one additional wireless signal based on a property of the at least one additional wireless signal.

The source of the wireless signal may be a portable electronic device, and establishing a wireless connection with the source of the wireless signal by the electronic device may include establishing a wireless connection with the portable electronic device by the electronic device.

The electronic device may determine that the distance between the electronic device and the portable electronic device is below the threshold when the property of the wireless signal indicates that the portable electronic device is positioned within a defined radius (e.g., about 1 meter, 30 centimeters, 10 centimeters, 1 centimeter, or 1 millimeter) of the electronic device.

The electronic device may determine that the distance between the electronic device and the source of the wireless signal is below the threshold when the property of the wireless signal is above a defined percentage (e.g., at least about 10%, 50%, 70%, 90%, or 99%) of a maximum value for the property of the wireless signal, wherein the maximum value for the property of the wireless signal corresponds to an at least approximately zero distance between the electronic device and the source of the wireless signal.

The property of the wireless signal based upon which the electronic device determines an indication of a distance between the electronic device and a source of the wireless signal may be selected from the group consisting of: a power of the wireless signal, a strength of the wireless signal, and a received signal strength indication (“RSSI”) of the wireless signal.

The electronic device may include a processor and a non-transitory processor-readable storage medium communicatively coupled to the processor, and the non-transitory processor-readable storage medium may store processor-executable proximity-based wireless connection instructions that, when executed by the processor, cause the electronic device to: wirelessly receive the wireless signal; determine the indication of the distance between the electronic device and the source of the wireless signal based on the property of the wireless signal; and in response to the electronic device determining that the distance between the electronic device and the source of the wireless signal is below a threshold: establish a wireless connection with the source of the wireless signal.

The method may further include scanning for wireless signals by the second device.

An electronic device may be summarized as including: a wireless receiver; a processor communicatively coupled to the wireless receiver; and a non-transitory processor-readable storage medium communicatively coupled to the processor, wherein the non-transitory processor-readable storage medium stores processor-executable proximity-based wireless connection instructions that, when executed by the processor, cause the electronic device to: wirelessly receive a wireless signal; determine an indication of a distance between the electronic device and a source of the wireless signal based on a property of the wireless signal; and in response to the electronic device determining that the distance between the electronic device and the source of the wireless signal is below a threshold: establish a wireless connection with the source of the wireless signal.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a flow-diagram showing a method of establishing a wireless connection between a first electronic device and a second electronic device in accordance with the present systems, devices, and methods.

FIG. 2 is a flow-diagram showing another method of establishing a wireless connection between a first electronic device and a second electronic device in accordance with the present systems, devices, and methods.

FIG. 3 is a schematic diagram of an electronic system that, in use, implements the method from FIG. 1 and/or the method from FIG. 2 in accordance with the present systems, devices, and methods.

FIG. 4 is an illustrative diagram showing an exemplary implementation of the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic devices, and in particular portable electronic devices such as wearable electronic devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

Portable electronic devices are ubiquitous throughout the world today, and the portability of such devices is significantly enhanced by the ability to communicate with other devices via wireless connections. However, the process of establishing a wireless connection is typically slow, cumbersome, and requires specific output(s) to and input(s) from the user. The various embodiments described herein provide systems, devices, and methods that establish proximity-based wireless connections. In some implementations, the proximity-based wireless connections taught herein may be established automatically by the electronic telecommunications devices involved with little to no input or direction from the user.

Throughout this specification and the appended claims, the term “wireless connection” is used to refer to a direct communicative link between at least two electronic devices that employs one or more wireless communication protocol(s), such as Bluetooth®, ZigBee®, WiFi®, Near Field Communication (NFC), or similar. In the art, a wireless connection is typically established by communicatively linking two devices through a process called “pairing.”

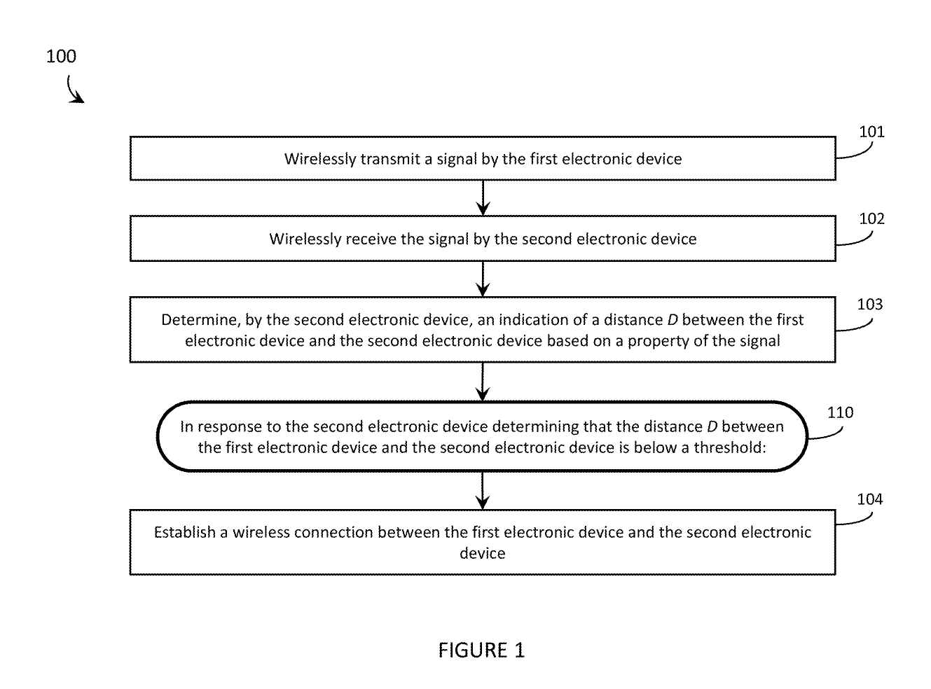

FIG. 1 is a flow-diagram showing a method 100 of establishing a wireless connection between a first electronic device and a second electronic device in accordance with the present systems, devices, and methods. The first electronic device may be a portable electronic device (e.g., a wearable electronic device) and the second electronic device may be any electronic device (i.e., portable or otherwise) that includes at least a wireless receiver (e.g., as part of a wireless transceiver) that, in use, receives wireless signals. That is, the second electronic device supports at least wireless receiving functionality and may, in addition, include any number of additional functionalities including, but not limited to, wireless transmitting functionality. The combination of a first electronic device and a second electronic device is also described throughout this specification and the appended claims as “an electronic system,” and therefore method 100 may be viewed as a method of operating such an electronic system.

Method 100 includes four acts 101, 102, 103, and 104 (depicted by rectangular boxes) and one criterion 110 (depicted by a rounded box), where act 104 is only performed when criterion 110 is satisfied. Thus, FIG. 1 depicts an implementation of method 100 for which criterion 110 is satisfied. Those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 101, the first electronic device (e.g., a portable electronic device) wirelessly transmits a signal. The first electronic device may include a wireless transmitter and wirelessly transmitting a signal may include broadcasting, multicasting, unicasting, or otherwise transmitting one or multiple signal(s) from the wireless transmitter, where the signal includes device identity information that at least partially identifies the first electronic device. For example, at 101 the first electronic device may be operated in an “advertising mode” in which wirelessly transmitting a wireless signal includes wirelessly transmitting advertising data comprising device identity information that “advertises” the first electronic device's identity and, in some implementations, device functionality information that “advertises” at least some of the first electronic device's functionality. A person of skill in the art and familiar with wireless communication protocols, and in particular with the Bluetooth® Low Energy protocol, will be familiar with the concept of advertising data. More generally, at 101 the first electronic device may be operated in a “connection establishment mode” in which the first electronic device wirelessly transmits one or more signal(s) in order to discover another electronic device (i.e., the second electronic device) with which to establish a wireless connection.

At 102, the second electronic device wirelessly receives the signals (e.g., at least one of the signals) wirelessly transmitted by the first electronic device at 101. As previously described, the second electronic device may include at least a wireless receiver that wirelessly receives the signals (at least one of the signals) wirelessly transmitted by the first electronic device. While, at 101, the first electronic device may wirelessly transmit one or more signal(s) in order to discover another electronic device with which to establish a wireless connection, at 102, the second electronic device may be operated in a “connection establishment mode” in which the second electronic device wirelessly scans for wireless signals in order to discover another electronic device (i.e., the first electronic device) with which to establish a wireless connection. Therefore, in some implementations, the second electronic device may scan for wireless signals that include device identity information before at least one such signal is wirelessly received by the second electronic device at 102.

At 103, the second electronic device determines an indication of a distance D between the first electronic device and the second electronic device based on a property of the wireless signal (i.e., the one or more wireless signal(s)) wirelessly received by the second electronic device at 102. Determining an indication of the distance D based on a property of the wireless signal may include determining the property of the wireless signal. For example, the second electronic device may determine a power or strength of the wireless signal and use this power or strength property as an indication of the distance D between the first electronic device and the second electronic device. Depending on compatibility with the specific wireless communication protocol being implemented, the power/strength property may be determined in the form of, for example, a received signal strength indicator (“RSSI”) or received channel power indicator (“RCPI”).

At 110, a criterion is specified and this criterion must be met before method 100 proceeds to act 104. The criterion is a threshold for the distance D between the first electronic device and the second electronic device. Method 100 only proceeds to act 104 in response to the second electronic device determining that the distance D is below the threshold. In other words, the criterion is a measure of the proximity of the first electronic device to the second electronic device and method 100 only proceeds to act 104 in response to the second electronic device determining that the proximity of the first electronic device satisfies the proximity criterion. Since the power/strength (and accordingly, RSSI/RCPI) of a wireless signal is inversely proportional to the distance from the source of the signal, the second electronic device may determine that the distance D is below a threshold indirectly by determining that the power/strength property is above a threshold. For example, the second electronic device may determine that the distance D between the first electronic device and the second electronic device is below the threshold when the property of the at least one signal is above a certain defined percentage (i.e., X %) of a maximum value for that property. Depending on the implementation, the percentage may be any percentage including, for example, at least about 10%, at least about 50%, at least about 70%, or at least about 90% of the maximum value for the property. When the property is a power/strength of the signal, the maximum value for the property may correspond to the transmitted strength/power of the signal (i.e., the power/strength of the signal at the point where the signal is transmitted as opposed to at the point where the signal is received) and/or the received strength/power of the signal that corresponds to an at least approximately zero distance D between the first electronic device and the second electronic device.

The second electronic device may be calibrated so that a property of the signal (e.g., a power/strength property of the signal) wirelessly received from the first electronic device provides an indication of the distance D between the first electronic device and the second electronic device. Thus, the threshold for the property of the signal may be defined to at least approximately correspond to a known distance D between the first electronic device and the second electronic device. For example, the threshold for the property may be defined so that the second electronic device determines that the distance D is below the threshold when the first electronic device is positioned within a specific distance or defined radius (i.e., Y centimeters) of the second electronic device. Depending on the implementation, this specific distance or defined radius may be, for example, about 1 meter or less, about 30 centimeters or less, about 10 centimeters or less, or about 1 centimeter or less.

As previously described, FIG. 1 depicts an implementation of method 100 in which criterion 110 is satisfied. Accordingly, method 100 proceeds to act 104.

At 104, a wireless connection is established between the first electronic device and the second electronic device. Establishment of the wireless connection may be initiated by the second electronic device and may include wirelessly connecting with the first electronic device by the second electronic device. Under some wireless communication protocols (e.g., Bluetooth®), establishing the wireless connection may include “pairing” the first electronic device and the second electronic device. Thus, at 104, the second electronic device wirelessly pairs with the first electronic device. The wireless connection established between the first electronic device and the second electronic device is a direct communicative link characterized by wirelessly exchanged signals that are configured for exclusive use by the first and/or second electronic devices. The wireless connection between the first electronic device and the second electronic device may be one-way (e.g., wireless signals are transmitted by the first electronic device and received and processed by the second electronic device) or two-way (e.g., wireless signals are transmitted by the first electronic device and received and processed by the second electronic device and wireless signals are transmitted by the second electronic device and received and processed by the first electronic device).

In method 100, a wireless connection may be automatically established between a first electronic device and a second electronic device (per act 104) when a distance D between the first electronic device and the second electronic device is brought below a specified threshold. The first electronic device is a portable electronic device, and in implementation a user may deliberately cause a wireless connection to be established between the first electronic device and the second electronic by physically displacing the portable first electronic device and bringing the first electronic device into close proximity to the second electronic device. Once established, the wireless connection between the first electronic device and the second electronic device may remain in effect when the devices are physically separated and the distance D therebetween is increased (within the limits of the wireless signal range).

The second electronic device may include a processor (e.g., communicatively coupled to the wireless receiver of the second electronic device) that controls the implementation of acts 102, 103, and 104 of method 100. The processor may be any type of processor, including but not limited to: a digital microprocessor or microcontroller, an application-specific integrated circuit (ASIC), a field-programmable gate array (FPGA), a digital signal processor (DSP), a graphics processing unit (GPU), a programmable gate array (PGA), a programmable logic unit (PLU), or the like. In the case of a digital architecture, the second electronic device may further include a non-transitory processor-readable storage medium or memory communicatively coupled to the processor, where the memory stores processor-executable instructions that, when executed by the processor, cause the second electronic device to perform acts 102, 103, and 104 of method 100. More specifically, the memory may store processor-executable “proximity-based wireless connection” instructions that, when executed by the processor, cause the second electronic device to wirelessly receive (per act 102 of method 100) the signal wirelessly transmitted (per act 101 of method 100) by the first electronic device, determine (per act 103 of method 100) the indication of the distance D between the first electronic device and the second electronic device based on the property of the signal, and (in response to the second electronic device determining that the distance D is below the threshold) establish the wireless connection (per act 104 of method 100) between the first electronic device and the second electronic device.

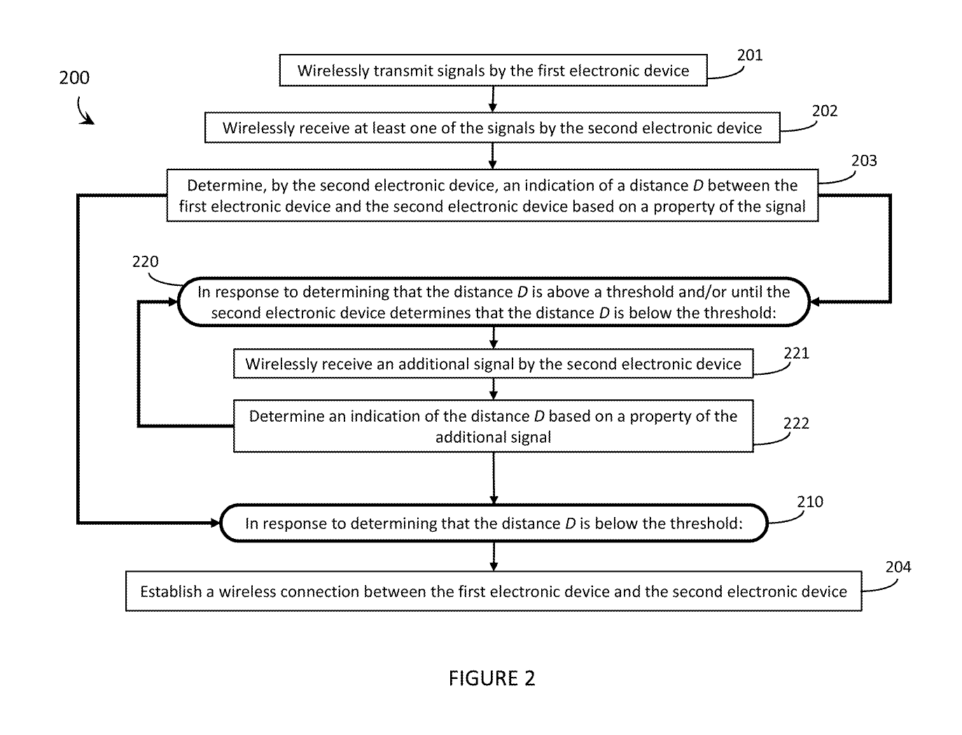

As previously described, FIG. 1 depicts an implementation of method 100 for which criterion 110 is satisfied and so the method proceeds to act 104. However, in some scenarios criterion 110 may not be immediately satisfied. An implementation of method 100 in which criterion 110 is not immediately satisfied is illustrated in FIG. 2.

FIG. 2 is a flow-diagram showing a method 200 of establishing a wireless connection between a first electronic device and a second electronic device in accordance with the present systems, devices, and methods. Method 200 is substantially similar to method 100 from FIG. 1, except that method 200 is an example of an implementation of method 100 for which criterion 110 is not initially satisfied.

Method 200 includes six acts 201, 202, 203, 221, 222, and 204 (depicted by rectangular boxes) and two criteria 210 and 220 (depicted by rounded boxes), though those of skill in the art will appreciate that some acts may be omitted and/or additional acts may be added. Acts 201, 202, 203, and 204 are substantially similar to acts 101, 102, 103, and 104, respectively, from method 100, and criterion 210 is substantially similar to criterion 110 from method 100. In brief: at 201, the first electronic device wirelessly transmits signals in a substantially similar way to act 101 of method 100; at 202, the second electronic device wirelessly receives at least one of the signals in a substantially similar way to act 102 of method 100; at 203, an indication of a distance D between the first electronic device and the second electronic device is determined by the second electronic device based on a property of the at least one signal in a substantially similar way to act 103 of method 100; at 210, a criterion is specified in a substantially similar way to criterion 110 from method 100 and this criterion must be met before method 200 proceeds to act 204; and at 204, a wireless connection is established between the first electronic device and the second electronic device in a substantially similar way to act 104 from method 100 in response to criterion 210 being satisfied.

Act 204 is only performed when criterion 210 is satisfied, and FIG. 2 depicts an implementation of method 200 for which criterion 210 is not initially satisfied by the first at least one wireless signal received at act 202. To this end, method 200 includes criterion 220, which is defined as the converse of criterion 210 such that criterion 220 is inherently satisfied when and while criterion 210 is not satisfied. The criterion at 220 is satisfied when the second electronic device determines that the distance D is above the threshold and/or until the second electronic device determines that the distance D is below the threshold. Depending on the implementation, either criterion 210 or criterion 220 may be extended to include the situation where the second electronic device determines that the distance D is equal to the threshold. In the implementation of method 200 depicted in FIG. 2, the first wireless signal received at act 202 satisfies criterion 220 and does not satisfy criterion 210.

Per criterion 220, in response to the second electronic device determining that the distance D is above the threshold and/or until the second electronic device determines that the distance D is below the threshold (i.e., until criterion 210 is satisfied), acts 221 and 222 of method 200 are performed. Iterations of acts 221 and 222 may be repeated in series until criterion 210 is satisfied. For acts 221 and 222, the second electronic device may be operating in a “connection establishment mode” and therefore iterations of acts 221 and 222 may be repeated indefinitely until a wireless connection is eventually established (per act 204) or until the second electronic device is taken out of connection establishment mode (either manually by the user or automatically in response to, for example, a defined elapsed time or a defined number of iterations of acts 221 and 222).

At 221 (i.e., at each successive iteration of act 221 until criterion 210 is satisfied), the second electronic device wirelessly receives an additional one of the signals wirelessly transmitted by the first electronic device at 201. Thus, act 221 is substantially similar to act 202 and is performed when the first at least one signal wirelessly received at 202 satisfies criterion 220 (i.e., does not satisfy criterion 210).

At 222, an indication of the distance D between the first electronic device and the second electronic device is determined by the second electronic device based on a property of the additional signal. Thus, act 222 is substantially similar to act 203 and is performed using the additional signal received at act 221 when the first at least one signal received at 202 satisfies criterion 220 (i.e., does not satisfy criterion 210). If the distance D determined at 222 for an additional signal received at 221 satisfies criterion 220 and not criterion 210, then method 200 repeats acts 221 and 222 for another additional signal wirelessly transmitted at 201. If and when the distance D determined at 222 for an additional signal received at 221 satisfies criterion 210 and not criterion 220, then method 200 proceeds to act 204 and a wireless connection is established between the first electronic device and the second electronic.

As will be apparent to a person of skill in the art, methods 100 and 200 are of particular utility when the distance D between the first electronic device and the second electronic is variable; for example, when at least one electronic device (e.g., the “first electronic device”) moves or is moving or is movable relative to another electronic device (e.g., the “second electronic device”). This is why, in the descriptions of both methods 100 and 200, at least one electronic device (i.e., the first electronic device) is identified as a portable electronic device. In an environment containing many electronic devices with wireless communication functionality (e.g., in a room containing a laptop, a smartphone, a smart television, and a wearable heads up display), methods 100 and 200 enable a user to select a particular wireless connection among multiple available/potential wireless connections by simply positioning, temporarily, a first one of the electronic devices in close proximity (e.g., within a defined radius, such as within 30 cm, within 10 cm, within 1 cm, or touching, depending on the implementation as previously described) to a second one of the electronic devices. For example, by implementing method 200, a user may automatically wirelessly connect two electronic devices by simply tapping them together. Methods 100 and 200 are particularly advantageous when a first one of the electronic devices is a control/interface device that may be used to selectively control multiple individual ones of the other available electronic devices.

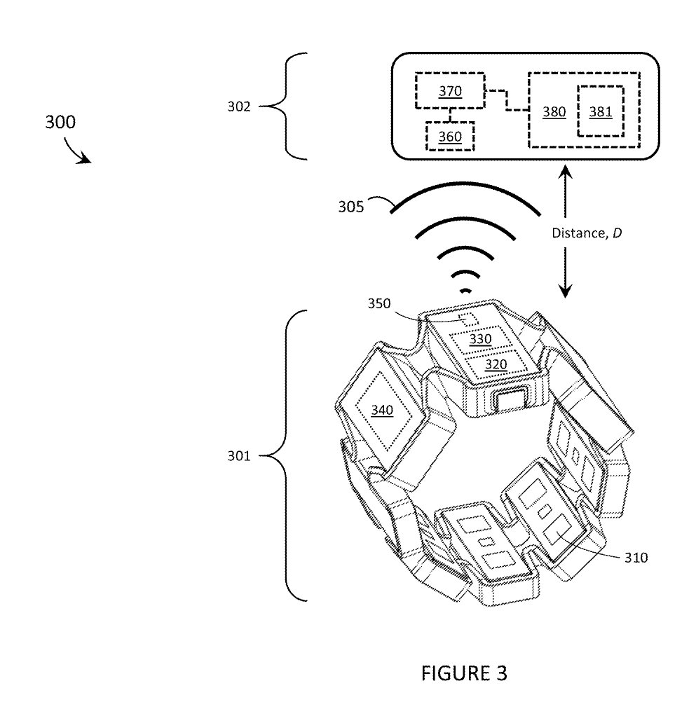

FIG. 3 is a schematic diagram of an electronic system 300 that, in use, implements methods 100 and/or 200 in accordance with the present systems, devices, and methods. Electronic system 300 includes a first electronic device 301 and a second electronic device 302. First electronic device 301 is a portable electronic device and performs the acts attributed to “the first electronic device” in methods 100 and 200. Second electronic device 302 includes, at least, a wireless receiver 360 (e.g., as part of a wireless transceiver) and performs the acts attributed to “the second electronic device” in methods 100 and 200. Second electronic device 302 may or may not be a portable electronic device.

In order to carry out the acts attributed to “the second electronic device” in methods 100 and 200, second electronic device 302 also includes a processor 370 communicatively coupled to wireless receiver 360 and a non-transitory processor-readable storage medium or memory 380 communicatively coupled to processor 370. Memory 380 stores processor-executable “proximity-based wireless connection” instructions 381 that, when executed by processor 370, cause second electronic device 302 to establish a wireless connection with first electronic device 301 when the distance D between first electronic device 301 and second electronic device 302 is below a defined threshold. More specifically, the proximity-based wireless connection instructions 381, when executed by processor 370, cause second electronic device 302 to perform acts 102, 103, and 104 of method 100 when criterion 110 of method 100 is immediately satisfied, or acts 202, 203, 221, 222, and 204 when criterion 110/210 is not immediately satisfied but eventually becomes satisfied due to a displacement of first electronic device 301.

As previously described, methods 100 and 200 are particularly advantageous when a first one of the electronic devices is a control/interface device. To exemplify this scenario, first electronic device 301 is a wearable gesture-based control device that, in use, is worn on an arm of a user and employs muscle activity sensors 310 to detect or sense when the user performs physical gestures with the arm (e.g., electromyography and/or mechanomyography sensors). However, exemplary gesture-based control device 301 is described only as an illustrative example of a “first electronic device” that may perform the corresponding acts in methods 100 and 200. A person of skill in the art will appreciate that the teachings herein may be applied with or otherwise incorporated into other forms of electronic devices, including other wearable electronic devices and other control/interface devices.

In addition to muscle activity sensors 310, gesture-based control device 301 includes a processor 320 communicatively coupled to the sensors 310, a non-transitory processor-readable storage medium or memory 330 communicatively coupled to the processor 320, and a battery 340. Memory 330 may store processor-executable instructions (e.g., processor-executable wireless connection instructions) that, when executed by processor 320, cause gesture-based control device to perform at least act 101 of method 100 and/or act 201 of method 200 and establish a wireless connection with second electronic device 302 per act 104 of method 100 and/or act 204 of method 200. To this end, gesture-based control device 301 also includes at least a wireless transmitter 350 (e.g., as part of a wireless transceiver) that, in response to direction from processor 320 based on executing instructions stored in memory 330, wirelessly transmits (per act 101 of method 100 and/or act 201 of method 200) wireless signals 305 that include any or all of: advertising data, device identity information that at least partially identifies gesture-based control device 301, and/or device functionality information that at least partially describes a functionality (i.e., control/interface functionality in the example of FIG. 3) of device 301. Further details of an exemplary gesture-based control device that may advantageously implement the present systems, devices, and methods are described in U.S. Provisional Patent Application Ser. No. 61/857,105 (now US Patent Publication US 2015-0025355 A1); U.S. Provisional Patent Application Ser. No. 61/860,063 and U.S. Provisional Patent Application Ser. No. 61/822,740 (now combined in US Patent Publication US 2014-0334083 A1); U.S. Provisional Patent Application Ser. No. 61/940,048 (now U.S. Non-Provisional patent application Ser. No. 14/621,044); U.S. Provisional Patent Application Ser. No. 61/872,569 (now US Patent Publication US 2015-0065840 A1); U.S. Provisional Patent Application Ser. No. 61/866,960 (now US Patent Publication US 2015-0051470 A1); U.S. patent application Ser. No. 14/186,878 (now US Patent Publication US 2014-0240223 A1), U.S. patent application Ser. No. 14/186,889 (now US Patent Publication US 2014-0240103 A1), U.S. patent application Ser. No. 14/194,252 (now US Patent Publication US 2014-0249397 A1), U.S. Provisional Patent Application Ser. No. 61/869,526 (now US Patent Publication US 2015-0057770 A1), U.S. Provisional Patent Application Ser. No. 61/909,786 (now U.S. Non-Provisional patent application Ser. No. 14/553,657); U.S. Provisional Patent Application Ser. No. 61/881,064 (now US Patent Publication US 2015-0084860 A1); U.S. Provisional Patent Application Ser. No. 61/894,263 (now U.S. Non-Provisional patent application Ser. No. 14/520,081); U.S. Provisional Patent Application Ser. No. 61/954,379 (now U.S. Non-Provisional patent application Ser. No. 14/658,552), U.S. Provisional Patent Application Ser. No. 61/971,346 (now U.S. Non-Provisional patent application Ser. No. 14/669,878), and U.S. Provisional Patent Application Ser. No. 61/915,338 (now U.S. Non-Provisional patent application Ser. No. 14/567,826), each of which is incorporated herein by reference in its entirety.

Methods 100 and 200 are implemented by an electronic system that includes both a first electronic device which performs wireless signal transmission/broadcasting per 101 and 201 (in addition to, in some implementations, having a role in establishing a wireless connection per acts 104 and 204) and a second electronic device which receives the transmitted wireless signals (per acts 102 and 202) and processes the wireless signals (per acts 103, 203, 221, and 222 based on criteria 110, 210, and 220) in order to establish a proximity-based wireless connection with the first electronic device (per acts 104 and 204). In some implementations, the completion of acts by the second electronic device is substantially independent of the nature of the first electronic device. In such implementations, the first electronic device may simply be regarded as a “source” of one or more wireless signals and methods 100 and 200 may be simplified as methods of operating a single electronic receiving device (i.e., the second electronic device) in order to establish a wireless connection with a “source” of one or more wireless signals. Simplifying methods 100 and 200 may include, for example, removing acts 101 and 201, respectively, and performing only those acts attributed to the second electronic device in relation to one or more wireless signal(s) received from a “wireless signal source.”

In accordance with the present systems, devices, and methods, the respective roles of the “first electronic device” and the “second electronic device” may be swapped for one or more act(s). That is, which one of the first electronic device and the second electronic device performs each of the acts in method 100 and method 200 may vary in different implementations. Whichever of the first electronic device and the second electronic device behaves as a peripheral in one implementation may behave as the central/master in another implementation, and vice versa. In the exemplary embodiments described in FIG. 1, FIG. 2, and FIG. 3, the “first electronic device” is sometimes referred to as a “portable electronic device,” and the acts performed by the first electronic device are thus (in the exemplary embodiments) associated with a portable electronic device. However, in alternative implementations the second electronic device may be a portable electronic device while the first electronic device may or may not be a portable electronic device.

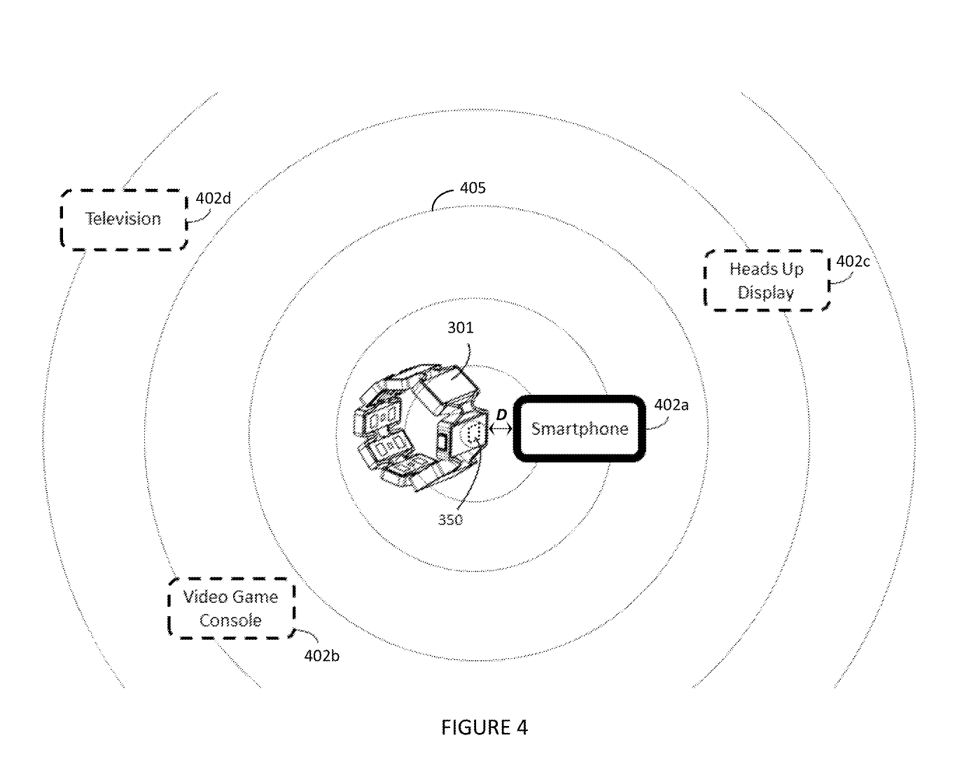

As previously described, methods 100 and 200 are particularly advantageous in environments where multiple electronic devices having wireless communication functionality are present but only a single one of the many available pairwise wireless connections is desired. FIG. 4 illustrates an example of this scenario.

FIG. 4 is an illustrative diagram showing an exemplary implementation of the present systems, devices, and methods. FIG. 4 depicts an environment that includes multiple electronic devices: a “first electronic device” in the form of gesture-based control device 301 from electronic system 300 of FIG. 3, and multiple candidate “second electronic devices”: a smartphone 402a, a video game console 402b, a heads-up display 402c, and a smart television 402d. In this example, each of candidate “second electronic devices” 402a, 402b, 402c, and 402d includes all of the features of second electronic device 302 of electronic system 300 from FIG. 3. Thus, in an implementation of method 200, gesture-based control device 301 wirelessly transmits wireless signals 405 (only one called out in the Figure) from wireless transmitter 350 per act 201. Each of candidate second electronic devices 402a, 402b, 402c, and 402d wirelessly receives at least one wireless signal 405 from gesture-based control device 301 per act 202. Each of candidate second electronic devices 402a, 402b, 402c, and 402d determines a respective distance D between itself and gesture-based control device 301 based on a property (such as the signal strength or power, e.g., in the form of an RSSI) of the received wireless signal 405 per act 203. For candidate second electronic devices 402b, 402c, and 402d, the corresponding distance D determined is above a threshold so criterion 220 of method 200 is satisfied. None of devices 402b, 402c, and/or 402d proceeds to establish a wireless connection with device 301. However, for candidate second electronic device 402a, the corresponding distance D is below the threshold (i.e., because device 402a is in very close proximity to device 301) and criterion 210 is satisfied. Therefore, candidate second electronic device 402a proceeds to establish a wireless connection with device 301 per act 204 of method 200. In other words, candidate electronic device 402a becomes “the second electronic device” 302 of electronic system 300. Thus, by selectively bringing gesture-based control device 301 in close proximity with candidate second electronic device 402a instead of any of candidate second electronic devices 402b, 402c, and/or 402d while at least gesture-based control device 301 and candidate second electronic device 402a are in respective “connection establishment modes,” the user deliberately establishes a wireless connection between devices 301 and 402a in an environment where multiple alternative wireless connections (e.g., between devices 301 and 402b, between devices 301 and 402c, and between devices 301 and 402d) are available. Once the wireless connection is established between devices 301 and 402a, the two devices may be physically separated (i.e., to increase the distance D beyond the threshold) with the wireless connection maintained and used for wireless communication between devices 301 and 402a until the wireless connection is severed (either automatically or based on input from the user) by either device. In some implementations, a first wireless connection may be automatically severed and a second wireless connection automatically established simply by bringing the first electronic device 301 in close proximity to a different candidate second electronic device 402b, 402c, or 402d while the first wireless connection is in effect. In alternative implementations, a first wireless connection may be sustained (once established) regardless of the subsequent proximities of other candidate second electronic devices and a second wireless connection may only be established once the first wireless connection is severed (either automatically or based on input from the user). Thus, by implementing the systems, devices, and methods described herein, a user is able to readily and selectively establish deliberate wireless connections while providing little to no input or direction to the electronic devices involved.

The various descriptions of systems, devices, and methods that establish proximity-based wireless connections provided herein make frequent reference to and use of a “threshold” for a property of a wireless signal. The value of this threshold depends on the desired implementation. For example, when the property of the wireless signal for which the threshold is established is a power/strength of the wireless signal, there exists an inverse relationship between the value of the threshold and the distance D required between the first and second electronic devices in order to trigger the establishment of a wireless connection therebetween. A larger threshold corresponds to a larger received signal strength/power (e.g., RSSI), which corresponds to a smaller distance D between the first and second electronic devices. In some implementations, the threshold may be set based on, for example, knowledge of the transmitted power P of the first electronic device (e.g., the threshold may be defined as a percentage of P), or based on empirical data for the received signal strength (i.e., RSSI) observed at the second electronic device when the first electronic device is positioned at various distances D therefrom.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to: U.S. Provisional Patent Application Ser. No. 61/978,608; U.S. Provisional Patent Application Ser. No. 61/857,105 (now US Patent Publication US 2015-0025355 A1); U.S. Provisional Patent Application Ser. No. 61/860,063 and U.S. Provisional Patent Application Ser. No. 61/822,740 (now combined in US Patent Publication US 2014-0334083 A1); U.S. Provisional Patent Application Ser. No. 61/940,048 (now U.S. Non-Provisional patent application Ser. No. 14/621,044); U.S. Provisional Patent Application Ser. No. 61/872,569 (now US Patent Publication US 2015-0065840 A1); U.S. Provisional Patent Application Ser. No. 61/866,960 (now US Patent Publication US 2015-0051470 A1); U.S. patent application Ser. No. 14/186,878 (now US Patent Publication US 2014-0240223 A1), U.S. patent application Ser. No. 14/186,889 (now US Patent Publication US 2014-0240103 A1), U.S. patent application Ser. No. 14/194,252 (now US Patent Publication US 2014-0249397 A1), U.S. Provisional Patent Application Ser. No. 61/869,526 (now US Patent Publication US 2015-0057770 A1), U.S. Provisional Patent Application Ser. No. 61/909,786 (now U.S. Non-Provisional patent application Ser. No. 14/553,657); U.S. Provisional Patent Application Ser. No. 61/881,064 (now US Patent Publication US 2015-0084860 A1); U.S. Provisional Patent Application Ser. No. 61/894,263 (now U.S. Non-Provisional patent application Ser. No. 14/520,081); U.S. Provisional Patent Application Ser. No. 61/954,379 (now U.S. Non-Provisional patent application Ser. No. 14/658,552), U.S. Provisional Patent Application Ser. No. 61/971,346 (now U.S. Non-Provisional patent application Ser. No. 14/669,878), and U.S. Provisional Patent Application Ser. No. 61/915,338 (now U.S. Non-Provisional patent application Ser. No. 14/567,826) are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of establishing a wireless connection between a first electronic device and a second electronic device, the method comprising:
wirelessly transmitting a signal by the first electronic device, wherein the signal wirelessly transmitted by the first electronic device includes device identity information that at least partially identifies the first electronic device;
wirelessly receiving, by the second electronic device, the signal wirelessly transmitted by the first electronic device;
determining, by the second electronic device, an indication of a distance between the first electronic device and the second electronic device based on a property of the signal wirelessly received by the second electronic device; and
in response to the second electronic device determining that the distance between the first electronic device and the second electronic device is below a threshold:
establishing a wireless connection between the first electronic device and the second electronic device.

2. The method of claim 1, further comprising:
wirelessly transmitting at least one additional signal by the first electronic device, wherein the at least one additional signal wirelessly transmitted by the first electronic device includes device identity information that at least partially identifies the first electronic device; and
in response to the second electronic device determining that the distance between the first electronic device and the second electronic device is above the threshold and/or until the second electronic device determines that the distance between the first electronic device and the second electronic device is below the threshold:
wirelessly receiving, by the second electronic device, at least one additional signal wirelessly transmitted by the first electronic device;
determining, by the second electronic device, an indication of a distance between the first electronic device and the second electronic device based on a property of the at least one additional signal wirelessly received by the second electronic device.

3. The method of claim 1 wherein the second electronic device determines that the distance between the first electronic device and the second electronic device is below the threshold when the property of the signal wirelessly received by the second electronic device is above a defined percentage of a maximum value of the property for the signal wirelessly received by the second electronic device, wherein the maximum value of the property corresponds to an at least approximately zero distance between the first electronic device and the second electronic device.

4. The method of claim 1 wherein the property of the signal wirelessly received by the second electronic device and based upon which the second electronic device determines an indication of a distance between the first electronic device and the second electronic device is selected from the group consisting of: a power of the signal, a strength of the signal, and a received signal strength indication (“RSSI”) of the signal.

5. The method of claim 1 wherein the second electronic device determines that the distance between the first electronic device and the second electronic device is below the threshold when the property of the signal wirelessly received by the second electronic device indicates that the first electronic device is positioned within a defined radius of the second electronic device.

6. The method of claim 1 wherein the second electronic device includes a processor and a non-transitory processor-readable storage medium communicatively coupled to the processor, and wherein the non-transitory processor-readable storage medium stores processor-executable proximity-based wireless connection instructions that, when executed by the processor of the second electronic device, cause the second electronic device to:
determine the indication of the distance between the first electronic device and the second electronic device based on the property of the signal wirelessly received by the second electronic device; and
in response to determining that the distance between the first electronic device and the second electronic device is below the threshold:
establish the wireless connection between the first electronic device and the second electronic device.

7. The method of claim 1, further comprising:
scanning for wireless signals that include device identity information by the second electronic device.

8. An electronic system comprising:
a first electronic device that includes a wireless transmitter, wherein in use the wireless transmitter wirelessly transmits a signal with device identity information that at least partially identifies the first electronic device, and wherein the first electronic device is a portable electronic device;
a second electronic device that includes a processor, a wireless receiver communicatively coupled to the processor, and a non-transitory processor-readable storage medium communicatively coupled to the processor, wherein the non-transitory processor-readable storage medium stores processor-executable proximity-based wireless connection instructions that, when executed by the processor, cause the second electronic device to:
wirelessly receive the signal wirelessly transmitted by the first electronic device;
determine an indication of a distance between the first electronic device and the second electronic device based on a property of the signal wirelessly received; and
in response to determining that the distance between the first electronic device and the second electronic device is below a threshold:
establish a wireless connection between the first electronic device and the second electronic device.

9. The electronic system of claim 8 wherein the processor-executable proximity-based wireless connection instructions, when executed by the processor of the second electronic device, further cause the second electronic device to, in response to the second electronic device determining that the distance between the first electronic device and the second electronic device is above the threshold and/or until the second electronic device determines that the distance between the first electronic device and the second electronic device is below the threshold:
wirelessly receive at least one additional signal wirelessly transmitted by the first electronic device; and
determine an indication of a distance between the first electronic device and the second electronic device based on a property of the at least one additional signal wirelessly received.

10. The electronic system of claim 8 wherein the signal wirelessly transmitted by the wireless transmitter of the first electronic device further includes at least one of: device functionality information that at least partially describes a functionality of the first electronic device and/or advertising data.

11. The electronic system of claim 8 wherein, when executed by the processor of the second electronic device, the processor-executable proximity-based wireless connection instructions cause the second electronic device to determine that the distance between the first electronic device and the second electronic device is below the threshold when the property of the signal wirelessly received by the second electronic device is above a defined percentage of a maximum value of the property for the signal wirelessly received by the second electronic device, wherein the maximum value of the property corresponds to an at least approximately zero distance between the first electronic device and the second electronic device.

12. The electronic system of claim 8 wherein the property of the signal wirelessly received by the second electronic device and based upon which the processor-executable proximity-based wireless connection instructions, when executed by the processor of the second electronic device, cause the second electronic device to determine an indication of a distance between the first electronic device and the second electronic device is selected from the group consisting of: a power of the signal, a strength of the signal, and a received signal strength indication (“RSSI”) of the signal.

13. The electronic system of claim 8 wherein, when executed by the processor of the second electronic device, the processor-executable proximity-based wireless connection instructions cause the second electronic device to determine that the distance between the first electronic device and the second electronic device is below the threshold when the property of the signal wirelessly received by the second electronic device indicates that the first electronic device is positioned within a defined radius of the second electronic device.

14. A method of operating an electronic device to establish a wireless connection, the method comprising:
wirelessly receiving a wireless signal by the electronic device;
determining, by the electronic device, an indication of a distance between the electronic device and a source of the wireless signal based on a property of the wireless signal; and
in response to the electronic device determining that the distance between the electronic device and the source of the wireless signal is below a threshold:
establishing a wireless connection with the source of the wireless signal by the electronic device.

15. The method of claim 14, further comprising, in response to the electronic device determining that the distance between the electronic device and the source of the wireless signal is above the threshold and/or until the electronic device determines that the distance between the electronic device and the source of the wireless signal is below the threshold:
wirelessly receiving, by the electronic device, at least one additional wireless signal; and
determining, by the electronic device, an indication of a distance between the electronic device and the source of the at least one additional wireless signal based on a property of the at least one additional wireless signal.

16. The method of claim 14 wherein the electronic device determines that the distance between the electronic device and the source of the wireless signal is below the threshold when the property of the wireless signal indicates that the source of the wireless signal is positioned within a defined radius of the electronic device.

17. The method of claim 14 wherein the electronic device determines that the distance between the electronic device and the source of the wireless signal is below the threshold when the property of the wireless signal is above a defined percentage of a maximum value for the property of the wireless signal, wherein the maximum value for the property of the wireless signal corresponds to an at least approximately zero distance between the electronic device and the source of the wireless signal.

18. The method of claim 14 wherein the property of the wireless signal based upon which the electronic device determines an indication of a distance between the electronic device and a source of the wireless signal is selected from the group consisting of: a power of the wireless signal, a strength of the wireless signal, and a received signal strength indication (“RSSI”) of the wireless signal.

19. The method of claim 14 wherein the electronic device includes a processor and a non-transitory processor-readable storage medium communicatively coupled to the processor, and wherein the non-transitory processor-readable storage medium stores processor-executable proximity-based wireless connection instructions that, when executed by the processor, cause the electronic device to:
wirelessly receive the wireless signal;
determine the indication of the distance between the electronic device and the source of the wireless signal based on the property of the wireless signal; and
in response to determining that the distance between the electronic device and the source of the wireless signal is below a threshold:
establish a wireless connection with the source of the wireless signal.

20. The method of claim 14, further comprising:
scanning for wireless signals by the electronic device.

21. An electronic device comprising:
a wireless receiver;
a processor communicatively coupled to the wireless receiver; and
a non-transitory processor-readable storage medium communicatively coupled to the processor, wherein the non-transitory processor-readable storage medium stores processor-executable proximity-based wireless connection instructions that, when executed by the processor, cause the electronic device to:
wirelessly receive a wireless signal;
determine an indication of a distance between the electronic device and a source of the wireless signal based on a property of the wireless signal; and
in response to the electronic device determining that the distance between the electronic device and the source of the wireless signal is below a threshold:
establish a wireless connection with the source of the wireless signal.
